(19) United States
(12) Patent Application Publication
(10) Pub. No.: US 2025/0229114 A1
(43) Pub. Date: Jul. 17, 2025

(54) RETRACTABLE ANCHOR DEVICE FOR FIXED LADDER

(71) Applicant: Thompson Fabricating, LLC, Tarrant City, AL (US)

(72) Inventor: Spencer Turner, Ragland, AL (US)

(73) Assignee: Thompson Fabricating, LLC, Tarrant City, AL (US)

(21) Appl. No.: 19/018,611

(22) Filed: Jan. 13, 2025

Related U.S. Application Data
(60) Provisional application No. 63/619,783, filed on Jan. 11, 2024.

(51) Int. Cl. A62B 35/00; E06C 7/18

(52) U.S. Cl. CPC A62B 35/0068; E06C 7/18

(57) ABSTRACT

A retractable anchor device is provided. The retractable anchor post may include a mounting portion configured to be attached to a ladder, a sleeve coupled to the mounting portion, a post slidably mounted within the sleeve, a locking mechanism to secure the post in an extended position, and an anchor point coupled to the post. The anchor point is configured to be coupled to a safety harness.

### CROSS-REFERENCE TO RELATED APPLICATION

The present application claims priority to U.S. Provisional Patent Application No. 63/619,783, entitled: Retractable Anchor Posts for a Fixed Ladder, filed on Jan. 11, 2024, the contents of which are hereby incorporated by reference in their entirety.

### TECHNICAL FIELD

The present disclosure relates generally to fixed ladders, and more specifically to safety devices to reduce the risk of a user falling while entering or exiting the top of a fixed ladder.

### BACKGROUND

Fixed ladders are ladders that are generally attached to a structure in a vertical position or a set angle. Fixed ladders are non-adjustable ladders that contain a set of rungs that allow a user to ascend or descend a structure. A fixed ladder may be mounted below a manhole cover or a roof hatch that the user may enter or exit at the top of the ladder. The fixed ladder is typically mounted below one side of the manhole cover or roof hatch, leaving space for the user to enter or exit by ascending or descending the fixed ladder. While the additional space is need to provide sufficient space for ingress and egress, the space also may create a danger of the user falling from the top of the ladder.

Additionally, the support structure that fixed ladders currently offer do not provide support for users who are not at the top of the ladder. Consequently, users who are climbing the ladder will typically not have any support when climbing the ladder, which becomes increasingly dangerous in windy, rainy, or other forms of inclement weather. The lack of support and protection creates a high-risk setting for using the ladder.

Other drawbacks include the lack of support users are offered if they decide to work on the structure at the top of the ladder. Some ladders contain a support structure set in the middle of the rungs that obstructs a user's ability to securely climb a ladder.

What is therefore needed is solution that provides additional support at various portions of the ladder.

### SUMMARY

According to an aspect of one or more examples, there is provided a retractable anchor device that may include a mounting portion configured to be attached to a ladder, a sleeve coupled to the mounting portion, a post slidably mounted within the sleeve, a locking mechanism to secure the post in an extended position, and an anchor point coupled to the post. The anchor point may be configured to be coupled to a safety harness. The retractable anchor device may include a safety pin removably insertable through a hole in the post to prevent the post from moving from an extended position to a fully retracted position.

The post and the sleeve may have a hexagonal cross-section. The post may include a locking channel formed within the post to receive the locking mechanism. The locking mechanism may include a handle that is hingedly coupled to the sleeve, and a locking portion sized and shaped to fit within the locking channel. The anchor point may include a U-bolt coupled to the post. The U-bolt may be integrally formed with the post. The U-bolt may include two leg portions that extend through the post, and two nuts configured to be respectively coupled to the two leg portions. The anchor point may include a first supporting plate disposed along an inner surface of the post, and a second supporting plate disposed on an outer surface of the post opposite from the first supporting plate.

According to an aspect of one or more examples, there is provided a method for making a retractable anchor device. The method may include forming a mounting portion configured to be attached to a ladder, providing a sleeve coupled to the mounting portion, positioning a post slidably mounted within the sleeve, providing a locking mechanism to secure the post in an extended position, and providing an anchor point coupled to the post, wherein the anchor point is configured to be coupled to a safety harness. The method may include providing a safety pin removably insertable through a hole in the post to prevent the post from moving from an extended position to a fully retracted position. The post may include a locking channel formed within post to receive the locking mechanism. The locking mechanism may include a handle that is hingedly coupled to the sleeve, and a locking portion sized and shaped to fit within the locking channel. The anchor point may include a U-bolt coupled to the post. The U-bolt may be integrally formed with the post. The U-bolt may include two leg portions that extend through the post, and two nuts configured to be respectively coupled to the two leg portions. The anchor point may include a first supporting plate disposed along an inner surface of the post, and a second supporting plate disposed on an outer surface of the post opposite from the first supporting plate.

### BRIEF DESCRIPTION OF DRAWINGS

FIG. 1 shows an elevation view of a retractable anchor device according to various examples.

FIG. 2 shows an elevation view of two retractable anchor devices according to various examples affixed to a ladder.

FIG. 3 shows a cross section view along line A-A in FIG. 2 of a retractable anchor device according to various examples.

FIG. 4 shows a cross section view along line B-B in FIG. 2 of a retractable anchor device according to various examples.

FIG. 5 shows a zoomed in view of an anchor point of a retractable anchor device according to various examples.

FIG. 6 shows a zoomed in view of a locking mechanism of a retractable anchor device according to various examples.

FIG. 7 shows a method of making a retractable anchor device according to various examples

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

Ladders are commonly used for a variety of applications in many different industries. By their nature, ladders pose a risk of falling to users as they are ascending or descending the ladder. The risk may be particularly heightened for ladders that are fixed to an existing structure, such as a wall, and the top of the ladder leads to an opening through which the ladder does not continue. For example, a ladder mounted to a wall to provide roof access on the top floor of a building, may have a top rung that is near a hatch that opens to allow access to the roof. As the user, who climbs to the top of the ladder, is accessing the roof through the hatch, the siderails or stringers of the ladder do not extend through the hatch, such that the user has nothing to grasp to keep from falling. The user may reach down to grasp the top rung of the ladder or the edge of the hatch opening, but reaching down while climbing out may cause the user to lose his or her balance and fall. Therefore, there is a need to provide a safety mechanism that allows a user to safely exit the top of a ladder.

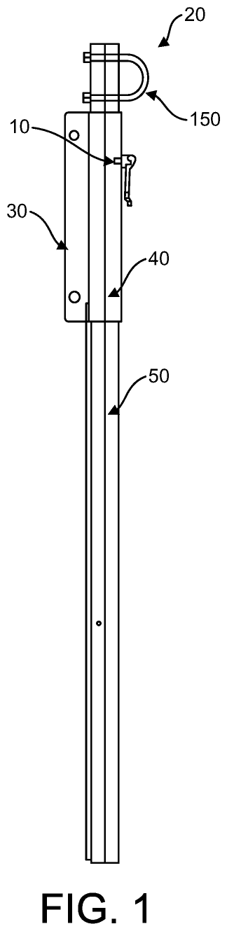

FIG. 1 shows an elevation view of a retractable anchor device according to various examples. The retractable anchor device may include a mounting portion 30 that is configured to be attached to a ladder. For example, the mounting portion 30 may be affixed to a siderail or stringer of a ladder, using a variety of fastening mechanisms such as, without limitation, bolts and U-bolts. The mounting portion 30 may also, or alternatively, be affixed to a rung of the ladder, such as the top rung of the ladder. According to various examples, the mounting portion 30 may be integrally formed with a stringer or rung, or both, of a ladder, or may be coupled to the stringer or rung (or both) using a nut 130 and bolt 140 or other suitable fastening mechanism, as explained further below.

The retractable anchor device may include a sleeve 40 that is coupled to the mounting portion 30. For example, the sleeve 40 may be integrally formed with the mounting portion 30, or may be affixed to the mounting portion 30 using any suitable fastening mechanism. According to various examples, the sleeve 40 may be disposed such that when the mounting portion 30 is affixed to a ladder, the sleeve 40 is located outside the siderail or stringer of the ladder. A post 50 may be slidably mounted within the sleeve 40, such that the post 50 may slide between a fully extended position and a fully retracted position. For example, when mounted on a stationary ladder fixed to a wall below an opening such as a roof hatch or manhole cover, the post 50 may be located below such an opening when in the fully retracted position, as is shown in FIG. 1. When in the fully extended position, the post 50 may extend through the opening such that the user can grasp the post 50 to provide stability when the user is exiting the opening.

The retractable anchor device of FIG. 1 may include a locking mechanism 10 that may lock the post in place within the sleeve 40. According to various examples, the locking mechanism 10 may be located on an outer portion of the sleeve 40, and may extend into the sleeve 40 to engage the post 50. The retractable anchor device of FIG. 1 may also include an anchor point 20 coupled to the post 50. For example, the anchor point 20 may be coupled to a distal end of the post 50 that, when affixed to a ladder below an opening, extends out of the opening when the post 50 is in the fully extended position. The anchor point 20 may allow the user to couple the user's safety harness to the anchor point 20. As shown in FIG. 1, the anchor point 20 may be a U-bolt 150 that can be coupled to a user's safety harness by using a D-ring, for example. When coupled to the user's safety harness, the anchor point 20 may provide additional safety benefits by preventing a fall if the user loses his or her footing or balance on the ladder.

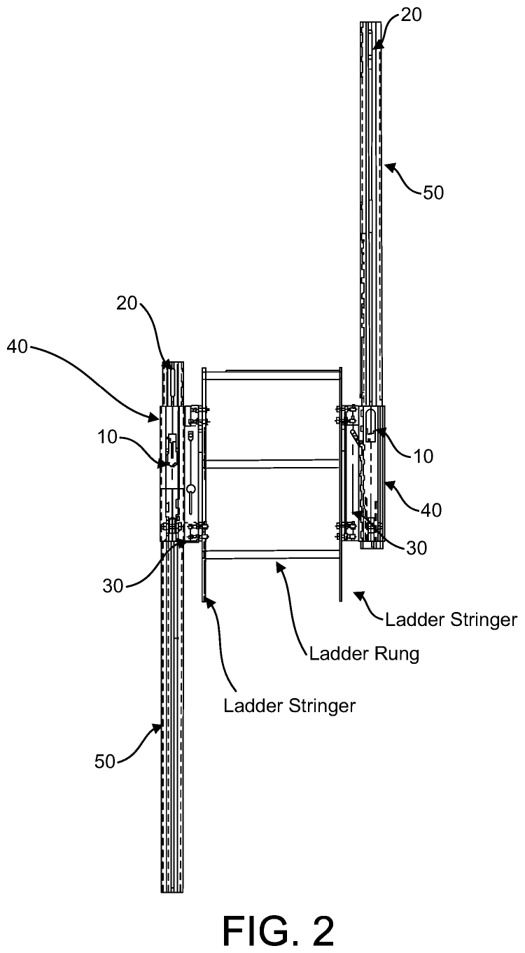

FIG. 2 shows an elevation view of two retractable anchor devices according to various examples affixed to a ladder. The retractable anchor devices of FIG. 2 are identical to the retractable anchor device of FIG. 1, but FIG. 2 shows the retractable anchor devices when affixed to a ladder. As shown in the example of FIG. 2, the retractable anchor devices are affixed to the stringers of the ladder. In addition, the retractable anchor device on the left side of FIG. 2 is in the fully retracted position, whereas the retractable anchor device on the right side of FIG. 2 is in the fully extended position. As described in more detail below, the locking mechanism 10 is used to lock the post 50 within the sleeve in the fully extended position. When both posts of the respective retractable anchor devices are in the fully extended position, the user has two points of stability to grasp as the user exits the top of the ladder. In addition, the posts 50 may have respective anchor points 20 that allow the user to couple the user's safety harness to either or both anchor points 20.

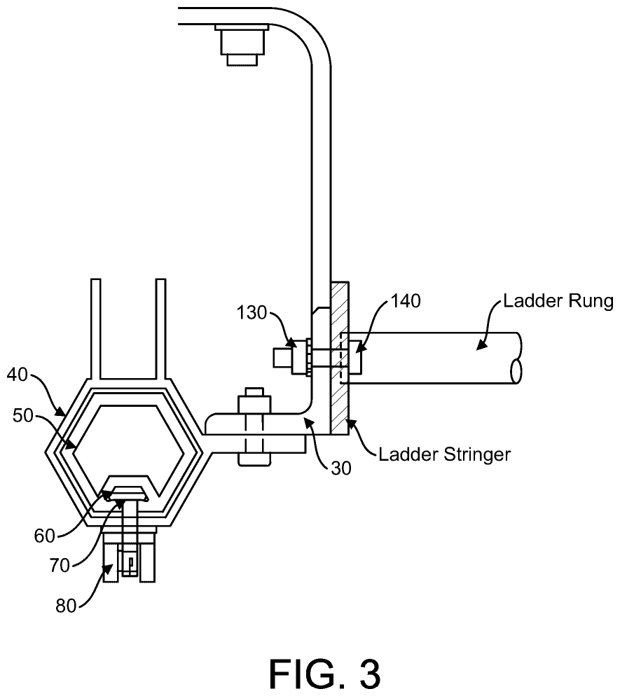

FIG. 3 shows a cross section view along line A-A in FIG. 2 of a retractable anchor device according to various examples. As shown in FIG. 3, the post 50 and the sleeve 40 according to various examples may have a hexagonal cross-section. The hexagonal cross-sectional shape may provide increased strength as compared to other cross-sectional shapes, such as round, square, or rectangular. The post 50 may have a locking channel 60 formed within the hexagonal cross section of the post 50 to receive the locking mechanism 10. For example, the locking channel 60 may be formed by two angled portions extending into the interior of the post 50 from one side of the hexagonal post 50. The two angled portions may be connected by a flat portion that may be approximately parallel to the side of the hexagonal post 50 where the two angled portions originate. The locking channel may be the cavity formed between the two angled portions, the flat portion, and the side of the hexagonal post 50.

As shown in FIGS. 2-3, the locking mechanism 10 may have a handle 80 and a locking portion 70. The handle 80 may be coupled to the outside of the sleeve 40, and the locking portion 70 may be coupled to the handle 80. The locking portion 70 may extend into the locking channel 60 to engage the post 50 and lock in place within the sleeve 40. According to various examples, the handle 80 may be hingedly coupled to the sleeve 40 to insert and remove the locking portion 70 into and from the locking channel 60. In the example of FIG. 3, the mounting portion 30 of the retractable anchor device is coupled to the ladder stringer using a nut 130 and bolt 140, though other fastening mechanisms may be used.

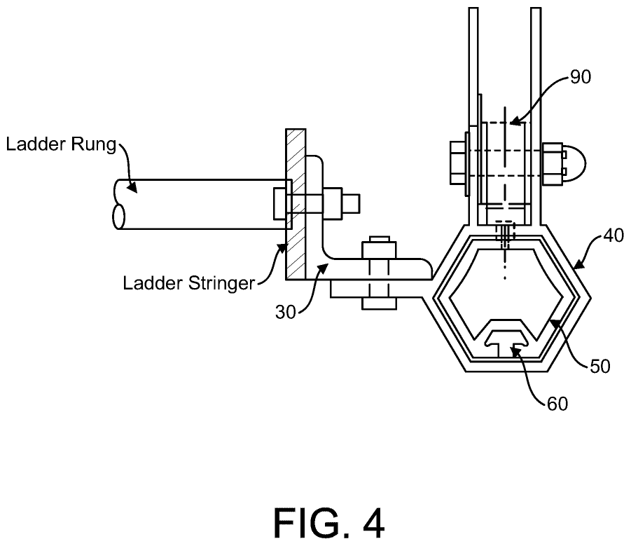

FIG. 4 shows a cross section view along line B-B in FIG. 2 of a retractable anchor device according to various examples. FIG. 4 shows a similar view of the retractable anchor device as FIG. 3, but without showing the locking mechanism 10. As shown in FIG. 4, the locking channel 60 is formed within the hexagonal post 50. According to various examples, the side of the hexagonal post 50 from which the locking channel 60 is formed may have a gap to accommodate the locking mechanism 10. The retractable anchor device may include a spring, such as a constant-force spring 90, as shown in FIG. 4, that biases the post 50 toward an extended position. When the user is moving the post 50 from a retracted position to an extended position, the user may have to move the post 50 in several motions. When the user lets go of the post to reposition the user's hand to continue raising the post 50, before the post 50 is in the fully extended position, the spring 90 may prevent the post 50 from falling back toward the retracted position.

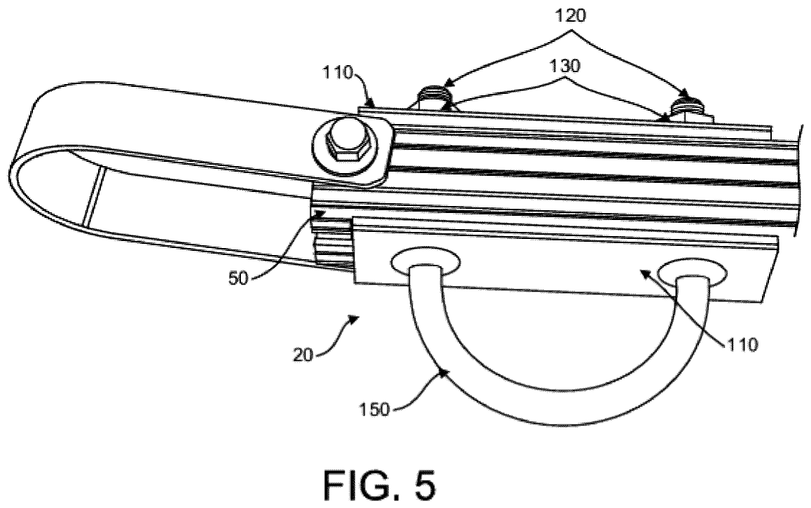

FIG. 5 shows a zoomed in view of an anchor point of a retractable anchor device according to various examples. The anchor point 20 of the example in FIG. 5 may include a U-bolt 150 that may have a curved portion and two leg portions 120 that extend through the post 50, and are secured to the post via corresponding nuts 130. The post 50 in FIG. 5 is shown having a rectangular or square cross-section, though other shapes, such as hexagonal, may be used. The anchor point 20 may include one or more supporting plates 110 to provide additional strength. For example, the anchor point 20 may include a supporting plate 110 adjacent to an outer side of one side of the post 50, and another supporting plate 110 on the outer side of another side of the post 50 opposite the first side. The supporting plates 110 may allow the anchor point 20 to better support a user's weight if the user were to fall when the user harness is attached to the anchor point 20. For example, the anchor point 20 may be able to resist an arresting force of 1800 pounds with a Safety Factor of 2 (or 3600 pounds total), in accordance with ANSI Z359.16. According to various examples, the anchor point 20 may be able to resist an impact load from a 500 pound weight dropped 18 inches in accordance with OSHA 29 CFR 1926.1053 (a)(22)(i), and/or support a 5,000 pound load in accordance with OSHA 29 CFR 1910.140 (c)(13)(i). These specifications are provided as examples only, and are not intended to be limiting.

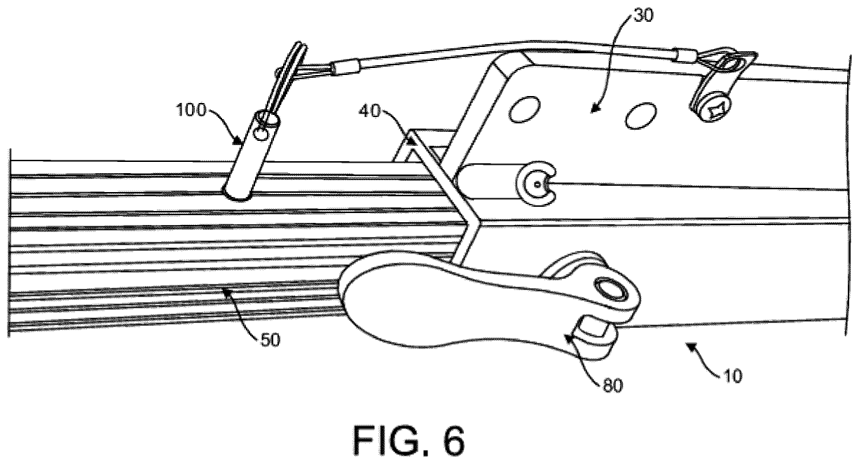

FIG. 6 shows a zoomed in view of a locking mechanism 10 of a retractable anchor device according to various examples. As shown in FIG. 6, the handle 80 of the locking mechanism 10 may be hingedly coupled to an outer side of the sleeve 40, in order to activate a locking portion 70 (not visible) to engage the post 50 within the sleeve 40. The retractable anchor device may also include a safety pin 100 that may be removably insertable through a hole in the post 50 to prevent the post from moving from an extended position to a fully retracted position. One end of the safety pin 100 may be coupled via a cable to, for example, the mounting portion 30 of the retractable anchor device. The safety pin 100 may extend through one or more sides of the post 50 such that if the post begins sliding from an extended position to a retracted position, the safety pin 100 will engage the sleeve 40 to prevent the post from sliding to a fully retracted position. Thus, the safety pin 100 provides an additional safety feature if the locking mechanism 10 fails to secure the post 50 in place within the sleeve 40.

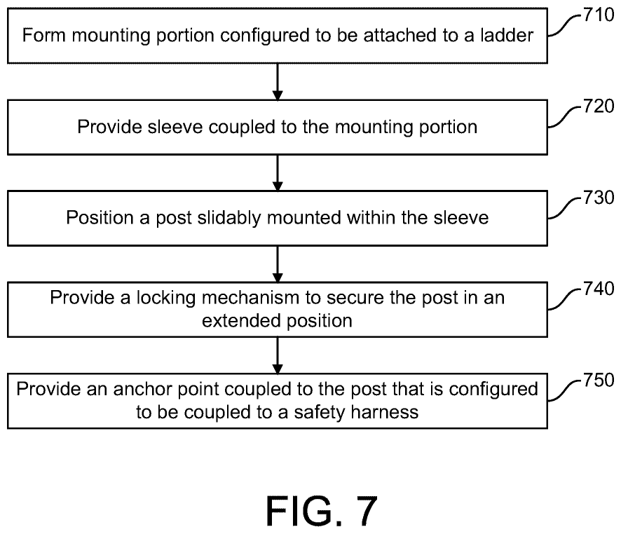

FIG. 7 shows a method of making a retractable anchor device according to various examples. The following description of the method of FIG. 7 may make reference to various components described above, which are shown for example purposes, and are not limiting. Referring to FIG. 7, in operation 710, a mounting portion such as mounting portion 30 may be provided such that it is configured to be attached to a ladder. In operation 720, a sleeve, such as sleeve 40 is provided and coupled to the mounting portion. In operation 730, a post, such as post 50, is positioned to be slidably mounted within the sleeve. In operation 740, a locking mechanism, such as locking mechanism 10, is provided to secure the post in an extended position. In operation 750, an anchor point is provided that is coupled to the post. The anchor point is configured to be a coupled to a safety harness

Various examples have been disclosed herein, in connection with the above description and the drawings. It will be understood that it would be unduly repetitious to literally describe and illustrate every combination and subcombination of these examples. Accordingly, all examples can be combined in any way and/or combination, and the present specification, including the drawings, shall be construed to constitute a complete written description of all combinations and subcombinations of the examples described herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A retractable anchor device comprising:
a mounting portion configured to be attached to a ladder;
a sleeve coupled to the mounting portion;
a post slidably mounted within the sleeve;
a locking mechanism to secure the post in an extended position; and
an anchor point coupled to the post, wherein the anchor point is configured to be coupled to a safety harness.

2. The retractable anchor device of claim 1, comprising a safety pin removably insertable through a hole in the post to prevent the post from moving from an extended position to a fully retracted position.

3. The retractable anchor device of claim 1, wherein the post and the sleeve have a hexagonal cross-section.

4. The retractable anchor device of claim 1, wherein the post includes a locking channel formed within the post to receive the locking mechanism.

5. The retractable anchor device of claim 4, wherein the locking mechanism includes a handle that is hingedly coupled to the sleeve, and a locking portion sized and shaped to fit within the locking channel.

6. The retractable anchor device of claim 1, wherein the anchor point includes a U-bolt coupled to the post.

7. The retractable anchor device of claim 6, wherein the U-bolt is integrally formed with the post.

8. The retractable anchor device of claim 6, wherein the U-bolt includes two leg portions that extend through the post, and two nuts configured to be respectively coupled to the two leg portions.

9. The retractable anchor device of claim 8, wherein the anchor point includes a first supporting plate disposed along an inner surface of the post, and a second supporting plate disposed on an outer surface of the post opposite from the first supporting plate.

10. A method for making a retractable anchor device, the method comprising:
forming a mounting portion configured to be attached to a ladder;
providing a sleeve coupled to the mounting portion;
positioning a post slidably mounted within the sleeve
providing a locking mechanism to secure the post in an extended position; and
providing an anchor point coupled to the post, wherein the anchor point is configured to be coupled to a safety harness.

11. The method of claim 10, further comprising providing a safety pin removably insertable through a hole in the post to prevent the post from moving from an extended position to a fully retracted position.

12. The method of claim 10, wherein the post includes a locking channel formed within the post to receive the locking mechanism.

13. The method of claim 12, wherein the locking mechanism includes a handle that is hingedly coupled to the sleeve, and a locking portion sized and shaped to fit within the locking channel.

14. The method of claim 10, wherein the anchor point includes a U-bolt coupled to the post.

15. The method of claim 14, wherein the U-bolt is integrally formed with the post.

16. The method of claim 14, wherein the U-bolt includes two leg portions that extend through the post, and two nuts configured to be respectively coupled to the two leg portions.

17. The method of claim 16, wherein the anchor point includes a first supporting plate disposed along an inner surface of the post, and a second supporting plate disposed on an outer surface of the post opposite from the first supporting plate.
